(19) United States
(12) Patent Application Publication
(10) Pub. No.: US 2008/0132218 A1
(43) Pub. Date: Jun. 5, 2008

(54) Method and Apparatus for Starting Applications

(76) Inventors: Yuval Samson, Bizaron (IL); Erez Dado, Nes Ziona (IL); Carmel Vernia, Tel Aviv (IL); Orit Himmel, Natanya (IL); David Sedaghati, Miami, FL (US)

Correspondence Address: GIBBONS P.C., ONE GATEWAY CENTER, NEWARK, NJ, 07102, US

(21) Appl. No.: 11/947,205

(22) Filed: Nov. 29, 2007

Related U.S. Application Data
(60) Provisional application No. 60/867,797, filed on Nov. 30, 2006.

(51) Int. Cl. H04M 3/00

(52) U.S. Cl. 455/418

(57) ABSTRACT

A method and apparatus for letting a user of a mobile device start an application by dialing. The number is either trapped by the mobile device, which starts an application that may connect to a server, or the server gets a signal from the mobile device, and sends back a message to the mobile device, causing it to initiate a session and connect to an IP address or a web page providing the service, or, over the voice channel, simultaneously (or not) with the vocal session, the server pass informational data, which causes a “listener” module on the client side such as the mobile phone which established connection with the server, to start a specific application, that may connect to a server which its address is given over the voice channel. The application or session is a multi-modal session passing audio, video, text, data, images, odor and the like.

### RELATED APPLICATION

The present invention relates and claims priority rights from U.S. provisional patent application Ser. No. 60/867,797 filed on Nov. 30, 2006. The entire content of U.S. 60/867,797 is incorporated herein by reference to the present application.

### TECHNICAL FIELD

The present invention relates to the field of starting computerized applications in general, and to an apparatus and method for starting applications by dialing a number, in particular.

### BACKGROUND

As portable devices are used more and more not only for vocal communication but also for consuming services, the inherent limitations of portable devices such as small screen and limited limit potential users from exchanging large amount of information. The screen is often limited to displaying a few lines of text. On the other hand, using a voice channel, like when calling IVR systems, have many problems: they are sequential, i.e. the user has to listen all the options before making his choice, a user has to concentrate all the time, a voice prompt disappears after it is said so any occasional noise can make the whole session useless, and more. Thus, IVR sessions are often tedious and frustrating and do not best serve the interest of the consumer or the provider. Thus, a graphic session can be useful in sessions like a consuming session. A graphic session can be useful under such circumstances. However, the access to such services, as well as transferring large amounts of data limit the abilities to offer and use such sessions.

Internet sites can be reached, among other methods, by a user typing a Uniform Resource Locator (URL). As more sites are created, each site optionally providing multiple services, the length of the URLs increase. This is a burden for a person typing the URL from a computer such as a laptop or a desktop computer, but a much harder burden for the user who wishes to connect from a small-size device, such as a mobile phone, a personal digital assistant (PDA) or similar ones, having a small-sized keyboard, usually a touchpad. Typing a long URL from such device is lengthy and error prone, thus actually banning many users from enjoying such services. As in the “chicken-egg dilemma”, this in turn causes operators not to develop rich sites, which altogether delays the development of mobile internet. Yet another problem is that even when an internet site is available through a mobile device, due to the small-sized display, the customer experience is limited relatively to a full-sized display to which the site is customized. Thus, multi-modal experience, including voice, video, data, text, and which can be operated using multiple input devices is generally not available for many types of mobile devices.

There is thus a need for a system and method that will enable easy access to sites, including sites that have lengthy URLs from mobile devices, including devices with small-sized displays. The sessions with such sites should be easy and intuitive, and should enable graphic presentation as well as transfer of large amounts of data despite the limitations of the used devices. The system and method should also enable a person to receive efficient multi-modal service from the site.

### SUMMARY

A method and apparatus for activating an application on a mobile communication device by sending an SMS or another signal form the device to a server, the server either answering the call or hanging up and dialing back, or the dialing itself is caught by the mobile device and activates the application.

In accordance with a preferred embodiment of the disclosure, there is thus disclosed a method for starting an application providing a service from a mobile communication device, the method comprising the steps of: generating a digital signal sequence; determining the service to be provided using the digital sequence; and starting execution of the application providing the service by the mobile communication device. The application is optionally a multi modal application. The application optionally comprises a step of a listener application trapping the digital signal sequence and starting the execution of the application. Within the method, the listener application optionally determines the application or a parameter thereof by matching a prefix or a suffix of the digital signal sequence or by comparing the digital signal sequence to one or more pre-determined numbers appearing in a table. The method can further comprise the steps of: sending the digital signal sequence to a server; and sending a notification from the server to the mobile communication device. The notification is optionally sent as a separate communication between the mobile communication device and the server. The notification can alternatively be sent as part of a communication established when the digital signal sequence was sent to the server. The notification optionally comprises an address for the mobile communication device to connect to. The method can further comprise a step of a establishing a multimodal session between the mobile communication device and an Internet Protocol address associated with the service. Within the method the multi modal session optionally comprises a voice session held substantially simultaneously with a data session. The session is optionally between a user of the mobile device and a representative, and the representative optionally assumes control over the mobile device. The service is optionally associated with the digital signal sequence or a part thereof. The notification is optionally a Global System for Mobile communications message or a short message or a Wireless Application Protocol link. The application is optionally a browser application.

Another aspect of the disclosure relates to an apparatus for starting an application providing a service, the application executed by a mobile communication device, the mobile communication device executing: a listener application; and the application providing the service to a user. Within the application, the listener application optionally traps a digital signal sequence dialed by a user using the mobile communication device. Within the apparatus, the application optionally invokes a multimodal session between the mobile communication device and a server. Within the apparatus, the server optionally executes: a network layer for communicating with the mobile communication device; a messaging server for sending or receiving messages to and from the mobile communication device; and a graphic user interface server for adapting information to be displayed to the user to one or more parameters of the mobile communication device. Within the apparatus, the messaging server optionally sends a message to the mobile communication device to start the application. Within the apparatus, the server optionally executes: a voice server for receiving and sending vocal information from or to the mobile communication device; and a multi modality server for synchronizing data between the voice server, the graphic user interface server and the mobile communication device. The apparatus can further comprise an application server for providing the service.

### BRIEF DESCRIPTION OF THE DRAWINGS

Non-limiting embodiments of the invention will be described with reference to the following description of exemplary embodiments, in conjunction with the figures. The figures are generally not shown to scale and any sizes are only meant to be exemplary and not necessarily limiting. In the figures, identical structures, elements or parts that appear in more than one figure are preferably labeled with a same or similar number in all the figures in which they appear, in which:

FIG. 1 is a schematic illustration of a typical configuration in which a preferred embodiment of the disclosure is used;

FIG. 2 is a flowchart of a preferred implementation of a method according to the disclosure;

FIG. 3 is a schematic block diagram of the components in a mobile device, in accordance with a preferred embodiment of the disclosure;

FIG. 4 is a schematic block diagram of the components in a server, in accordance with a preferred embodiment of the disclosure; and

FIG. 5 is a schematic illustration of a screen shot of a mobile device in a ticket-reservation session, in accordance with a preferred embodiment of the disclosure.

### DETAILED DESCRIPTION

A method and apparatus for initiating an application, such as a multimodal application, i.e. an application that combines exchanging multiple information types, such as graphics, voice, text, data, or others. The application may be a standalone application executed by a device used by the user, or a session between a user using a mobile device and a service provider. The application or session are initiated by dialing a number, either as when initiating a mobile call, by sending a short message (SMS), by merely pressing the digit sequence, or the like. In a preferred embodiment of the disclosure, if the mobile phone sends an SMS or initiates a phone call, may or may not be answered by the receiver. In one preferred embodiment, the server that received the call signal or the SMS signal detects the origin of the signal, and sends or causes to be sent a notification, such as a callback, a network notifications, a message, a signal or indication, such as a Global System for Mobile communications (GSM) message, a wake-up SMS, i.e. an SMS sent on a specific port or another signal back to the mobile device. The message, such as the wake-up SMS preferably uses the push registry technology that causes an application to be activated on the mobile device when such an event occurs. The sent message can also carry data required for activating an application. The message or signal, optionally sent on a specific port, initiate the execution of an application on the mobile device, the application optionally consuming the required service through a single or multimodal data session, or through simultaneous voice and data or IP sessions between the mobile device and the service provider. The started application may present one or more icons or Universal Resource Locators (URLs), that when clicked or otherwise pointed to by the user, connect to the service or a web site. The server receiving the signal may send a notification about the signal to a predetermined specific server as indicated by the phone number or another part of the sent message, the signal, preferably containing the telephone number or another identifier causes the required service provider to send a notification message such as a GSM message, wakeup SMS, packet IP, or alike, or issue a call to the mobile device.

In another alternative, the server receiving the call sends an SMS message which is a Wireless Application Protocol (WAP) link. When the user clicks or otherwise points on the link, a browser is opened and the user can consume the relevant service by browsing. The browser can be the default browser installed on the device, or any proprietary browser. In the embodiments detailed above, the server sends a notification which is separate form the initial communication. However, in yet another alternative, the dialed number is answered and a communication session is established between the mobile device and the service provider, such as a voice communication. Optionally, during the communication signals which may be inaudible for a human being are transmitted, captured by the portable device and acted upon. The signal can carry an IP address for the device to connect to a URL address to browse to, or other information.

In yet another alternative, a “listener” application traps the digit sequence dialed on the mobile device, determines that the sequence relates to a known service, optionally disconnects the call if a call started, and starts an application. The application can be executed by the device or initiate a multi modal data session between the mobile device and the service provider. The dialed number preferably matches a predefined prefix or suffix, for example 1-333-xxxx, wherein xxxx is specific to the service the user wishes to consume. Alternatively, the number can be associated with the service, such as a number made up of digits corresponding to the letters of the name of the service or to another word. In yet another alternative, a table associating one or more predefined numbers with IP addresses is maintained in the memory of the device mobile memory. When a number from the table is identified, a multimodal session is invoked with the corresponding address. The “listener” application may recognize the dialed number or a prefix or suffix thereof, and start the application with the relevant service as a parameter, indicating for example an IP address or a URL the application should connect to. Alternatively, the dialed number can be a general access number, which presents the user with multiple services to choose from.

Optionally, after the application starts, the user is asked whether browsing or otherwise accessing a server is approved, and only when he answers positively the application continues.

Once a session is established, it optionally makes use of multiple available types of data in a multimodal session. Thus, the session may comprise, for example, images, animated or moving images, audio, video, text, data, smell, and any other type of multimedia information. In addition, the user consuming the service may use any input or output device, including the keypad, voice, text, joystick or others.

The session can be held between the mobile device and a specific server providing the service, such as a bank that may not want sensitive data to pass through other servers. Alternatively, the session can be held between the mobile device and the server to which the initial signal was sent, the server holding a parallel session with the specific service provider. In this configuration the server initially called communicates between the service consumer and the service providing server.

The invoked application preferably comprises an internet browser or any other xml-like interpreter with optional plug-ins or other additions designed to utilize best the capabilities of the mobile device for specific proposes. For example, a plug-in may be installed and used which presents and enables the selection of seats in a cinema, a concert hall, a sports stadium or the like, for use in applications that provide ticket purchasing or reservations. When such dedicated plug-in is used, the server initially called optionally provides an application program interface (API) to be used by one or more specific servers that may use such browser capabilities but do not want to develop it from scratch.

In all embodiments, when the mobile device communicates with a service provider, a voice channel can be held substantially simultaneously with a data session, using the Wideband Code Division Multiple Access (WCDMA) protocol. The voice channel can be used for conversation with a service representative, for playing prompts, transfer user information such as DTMF or the like.

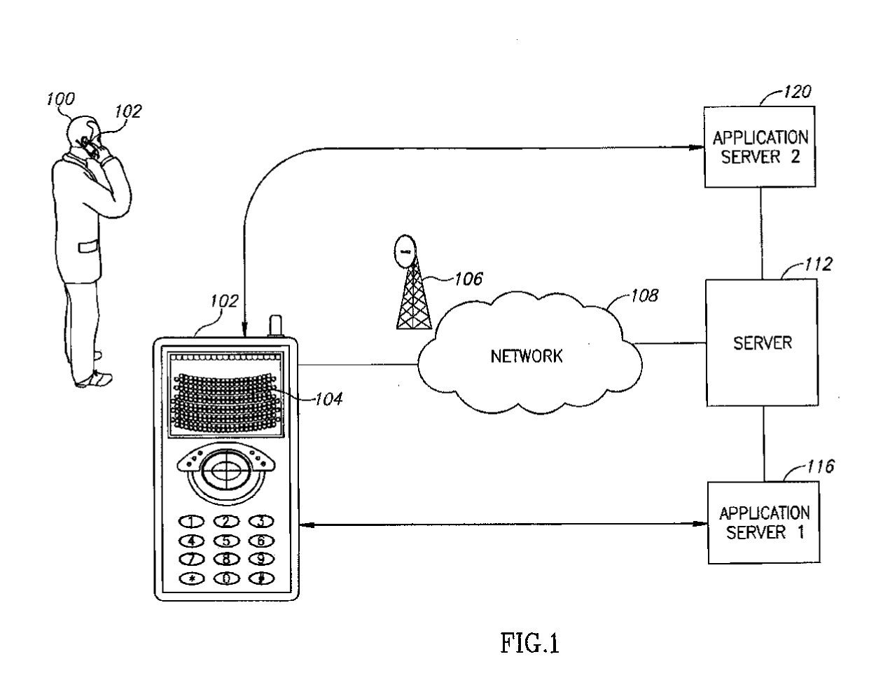

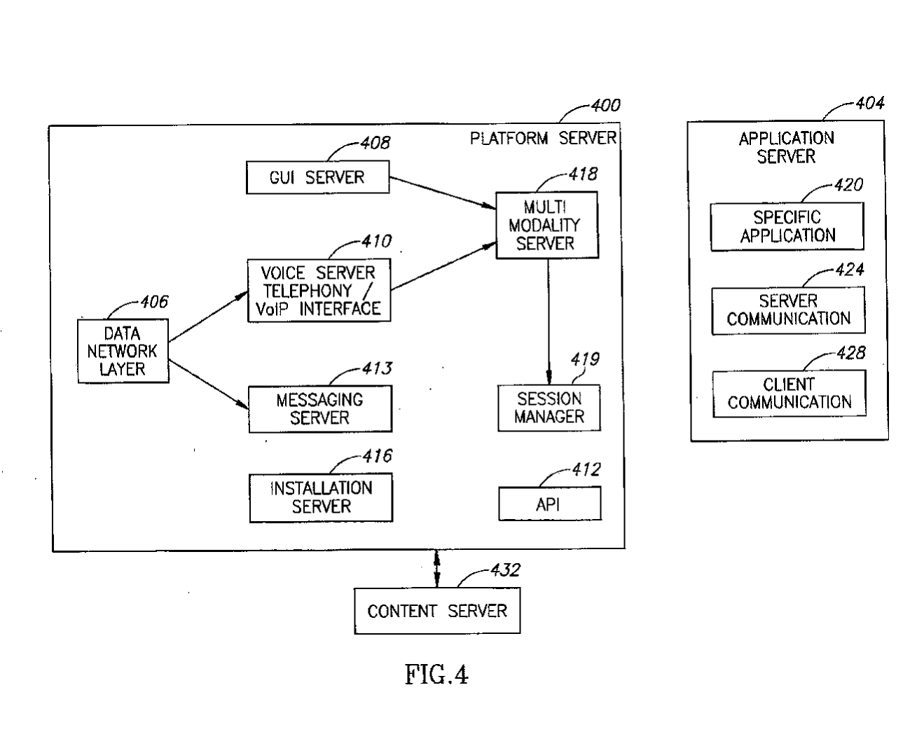

Referring now to FIG. 1, showing a schematic illustration of a typical configuration in which a preferred embodiment of the disclosure is used. The configuration is generally a client-server configuration, in which the client device is a mobile device 102, such as a cellular phone, a PDA, a soft IP-phone, or another device used by user 100. User 100 dials a number or sends an SMS to a predetermined number, preferably an easy-to-remember number or a number associated with the required service or a feature thereof. The call is transferred through a network such as a Wi-Fi network, a Wi-max network, any other IP network, a cellular network including for example cellular antenna 106 and other network components 108, or any other communication channel, to server 112, which is preferably a server having communication capabilities. The server should comprise communication equipment such as telephony cards, and additional equipment as detailed in association with FIG. 4 below. The call or SMS is preferably identified, i.e. comprises the number of device 102, and optionally additional details. Server 112 is optionally a general server, serving as gateway to multiple services. In such case, the sent message should also contain details as to the specific service required. Alternatively, server 112 is responsive to calls, SMSs or other notifications sent to multiple numbers, and according to the specific number, identifies the required service. Server 112 then either communicates with device 102 and supplies the service as detailed below, or notifies one or more specific servers, such as application server 1 (116) or application server 2 (120). Upon such notification, application server 1 (116) or application server 2 (120) can communicate directly with device 102, for example in sensitive applications in which the operator of application server 1 (116) does not want information to flow through server 108. Alternatively, application server 1 (116) or application server 2 (120) communicate indirectly, via server 112 with device 102. Device 102 uses application 104 throughout the communication for consuming the required service. Server 112, and optional application server 1 (116) or application server 2 (120) comprise the server side of the client-server configuration.

Device 102 is any device having internet connection capabilities and cellular capabilities, such as a cellular phone generation 2.5 or up, Personal Digital Assistance, a desktop or laptop computer equipped with dialing and voice over IP capabilities, or the like. Device 102 executes application 104, comprising computer instructions for carrying out the client side of the disclosed methods. Application 104 preferably comprises implementation of an internet browser designed to enhance the specific capabilities of the device. Application 104 can also comprise or connect to specific applications, or comprise components relevant for specific applications, such as an application for ticket purchasing and reservation, application that updates parts of the display in real time, such as a banking or stock investment application, or others.

Server 108 is any computing platform capable of sending and receiving a phone communication or SMS, and capable of executing web applications. Similarly, server 112 or server 116 can be any computing platforms capable of executing applications. In some embodiments, server 112 or server 116 do not require phone communication capabilities, but can rather communicate only with server 108. In another preferred alternative, the application performed by server 112 or server 116 can be performed by server 108, thus reducing the environment to a one-server environment providing the services.

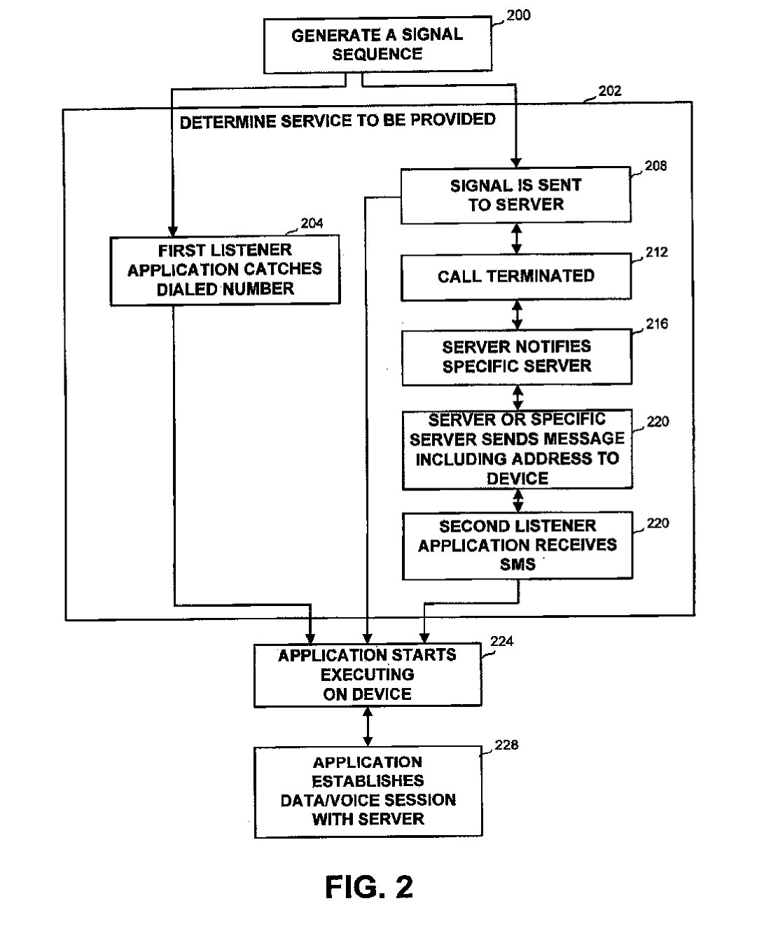

Referring now to FIG. 2, showing flowcharts of the main steps in the disclosed methods.

The method starts at step 200, in which a predetermined sequence of digits is dialed and a sequence of signals is generated by a device such as device 102 of FIG. 1. The number can be dialed by a user, like dialing a normal phone number, or like sending an SMS. Alternatively, the number is dialed by activating an application programmed to dial the predetermined number, for example through an icon. The number is preferably easy to remember or otherwise meaningful. The number optionally has a constant prefix or postfix, such as 1-300-xxxx wherein xxxx stands for further digits. Then on step 202, the service to be provided and optionally the mobile device to which the service is to be provided is determined. In a preferred embodiment implementing a first operation mode, on step 204 a listener application traps the dialed number. The listener application is optionally implemented as a daemon constantly executed by the mobile device, which traps pressed keys and using for example a state machine determines the typing of one or more predetermined combinations, or a numeric sequence starting or ending with a predetermined prefix. Alternatively, the listener application can trap the “send”, “dial”, “connect” or any other event. In a preferred implementation the listener performs the following activities: for numbers identified as associated with multimodal service, or for all numbers, the listener queries the server for an address of service associated with the number. If the dialed number is not identified by the daemon as a multimodal service number, or if the server does not reply to the query, then the call continues as usual. If the dialed number is indeed relates to a multimodal service, then the server which accepts the call, will send the daemon the address of the service using the signaling channel of the call or via other channel, such as an SMS, GSM message or the like. Preferably, multimodal numbers are stored and maintained by the mobile device for future uses.

Alternatively, in a second operation mode, on step 208 a signal is sent to a server responsive to the dialed sequence of digits, the signal comprising all data supplied by the user or by application that performed the dialing, such as the text of the SMS, parameters available to the application, information related to the mobile device or the like. The server should receive the phone number of the sending device, either as a caller-id number, or as additional parameter, for example as part of the text in the SMS message. On optional step 212, if a call between the device and the server was initiated, i.e., if the server answered the call, the call is optionally terminated. If the user does not terminate the call, the server can terminate it. If the call is not terminated, execution continues at step 224. On optional step 216, the server optionally notifies another server, such as an application server about the call or the SMS. The notification is performed if the other server is to supply at least part of the functionality or the data for the required service. The first server knows which other server to notify either according to the number dialed from the mobile device, details supplied in the SMS, pre-stored preferences associated with the phone number of the mobile device, or the like. In an exemplary embodiment the server stores a table indicating for each dialed number, one or more servers that should be notified when this number is dialed. The notification optionally comprises all required data, such as the phone number of the mobile device if the other server has to retrieve details associated with the phone number or to contact the mobile device. If the first server is the service supplier, then step 216 can be omitted. On step 220 the first server or the other server sends a message such as an SMS to the mobile device. The message optionally comprises an IP address or a URL address which can be as long as required and an activation code for starting the application that connects to the address. The application is optionally started using the PushRegistry mechanism of the J2ME environment. The SMS is preferably sent on a predetermined port of the mobile device, such as port 100. It will be appreciated that the second operation mode can only take place if the Automatic Number Identification (ANI) is enabled for the mobile device, otherwise an SMS can not be sent to it. On step 224, a second listener application traps the SMS on the predetermined port. The second listener application is optionally also a daemon application listening on the port. It will be appreciated by a person skilled in the art that the first listener application and the second listener application can be implemented as one application providing the two functionalities or as two separate applications. On step 224, the first listener application or the second listener application activate the operative application, which starts executing on the mobile devices. The operative application preferably starts a session optionally including internet browsing session and on step 228 establishes a multi modal data session with a specific IP address or URL. The data transferred during the multimodal session can be optimized or encrypted using any encryption or optimization protocol currently known or that will be developed in the future. Optionally, a voice channel is also opened between the mobile device and the server, for handling a conversation with a representative, passing DTMF or other vocal activities. The address or URL is either contained in the SMS sent to the mobile device, is available to the application from a configuration file, from being hard coded into the application or by any other method. The URL is preferably the address of a web page providing the desired service. In another alternative, the application starts by presenting to the user a list containing one or more IP addresses or URLs and optionally related information, and the user has to select one of the items in the list to which he wishes to connect. The list or other collection can be stored on the user's desktop, personal area or the like. The list can be configured within the application, within the mobile device or can be sent in the SMS. The session then continues until the service is provided, when the user exits the application. The multi modal s\data session transfers text, images, video, audio, text and any other kind of data between the mobile device and the service provider.

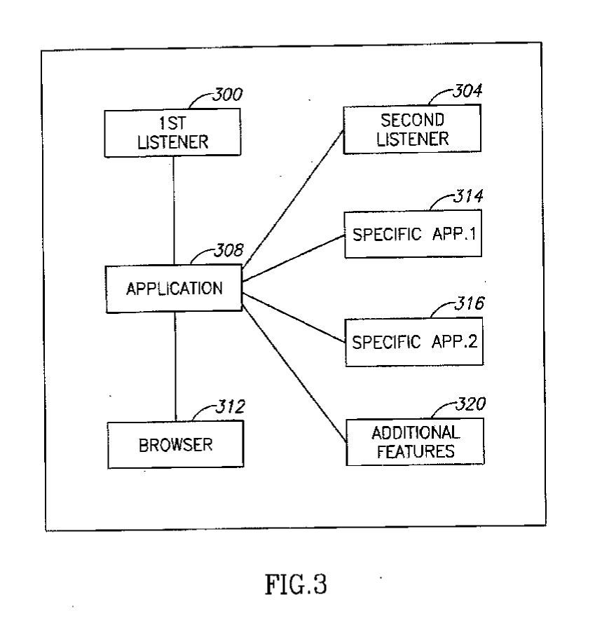

Referring now to FIG. 3, showing a block diagram of the components in a mobile device in a preferred implementation the disclosure. The block diagram details the components that should be installed on the mobile device, in order to perform the relevant steps and consume the services according to the disclosure. The components are preferably interconnected software components, implemented in any programming language, such as Java, C#, C++ or others and under any development environment, such as .NET, J2EE, j2me, symbian, brew, windows mobile, Linux, Open Handset Alliance, Android, or others. The components optionally comprise a first listener application 300, required if the operation mode of trapping a sequence of digits dialed by a user is to be implemented. First listener application 300 optionally traps the sending of the telephone number, the sending of the SMS or the connection of the device to the server. Alternatively, application 300 traps the dialing itself according to a prefix or a stored list of relevant numbers. The components further comprise a second listener application 304, required for trapping the message sent by the server to the mobile device in response to a sent call or SMS. At least one of first listener application 300 and second listener application 304 is installed on the mobile device in order to use the mobile device as detailed in the disclosure. However, first listener application 300 and second listener application 304 can both be installed, thus supporting the two operation modes. Second listener application 304 can be omitted if the mobile already has a listener, such as a Java PushRegistry or other mechanism. Optionally, when a vocal connection with the server is established, the server sends to the mobile device inaudible signals trapped by second listener application 304 which parses the signals and optionally performs one or more actions accordingly. Either first listener application 300 or second listener application 304 activates application 308, which is the application used by the user for consuming the required service. Application 308 presents the requested service to the user and lets the user make selections. Application 308 preferably comprises an internet browser 312, which is may be adapted to utilize the display and other characteristics of the used mobile device. Alternatively, browser 308 can be a standard browser or a third party browser for the mobile device. Application 308 optionally comprises or connects to one or more specific applications, such as specific application 1 (314) or specific application 2 (316), designed for providing specific functionalities, such as seat arrangement presentation, real time capabilities for example for stock quotes, arrivals and departure times, or other types of applications. Specific application 1 (314) or specific application 2 (316) can be implemented as part of application 308 or as separate components. Alternatively, each component may be an external application or functionality supplied by a third party, operator or other. One or more components can also be supplied by the device manufacturer. For example, dialing a predetermined sequence such as *123 will initiate the device's default contact manager. Additional features 320, such as enhanced vocal features, speech to text capabilities for operating IVR components via speech can also be implemented as part of application 308 or separately. Specific application 1 (314) or specific application 2 (316) or any one or more of additional features 320 can be implemented as plug-ins to browser 312, and thus be integrated in the operation of the browser. It will be appreciated that application 308 can be implemented as one or more different applications, designed for offering different services. If application 308 is implemented as multiple applications, the choice which application to start depends on the specific number dialed when the first operation mode is used, or on data arriving in the SMS call when the second operation mode is used. If application 308 is implemented as a single application with multiple options, then the same parameters and data are useful in determining which options of application 308 to invoke.

Referring now to FIG. 4, showing a block diagram of the components in the server side in a preferred implementation the disclosure. The server side is responsible to enabling a mobile device to consume services by dialing a sequence of numbers, according to the method detailed above. The functionality of the server can be implemented in a single server platform communicating with the client and providing the service, or multiple interconnected servers. A preferred configuration comprises platform server 400 which is the server that receives the dialed number, SMS or another indication from the mobile device, or is first connected to by the application executing on the mobile device, and optionally one or more application server 404 for supplying a predetermined service. Platform server 400 comprises multiple servers detailed below. Platform server 400 is preferably a computing platform such as a personal computer, a mainframe computer, or any other type of computing platform provisioned with a memory device (not shown), a CPU or microprocessor device, and several I/O ports (not shown). The servers comprised in platform server are preferably implemented as interconnected software components as detailed in association with FIG. 3 above. Platform server 400 comprises a data network layer 406 which manages the communication with the client devices, optionally including optimization, encryption and decryption, connection management or the like. Platform server 400 also comprises a Graphic User Interface (GUI) Server 408 responsible for the adaptation of the application view according to the user's device's parameters and to transfer user input to multimodality server 418 detailed below. For example, lower resolution information is sent to a mobile device having a relatively small display, or currently having low bandwidth coverage. The type of device is preferably known from the initial signal sent by the device to the server. Platform server 400 further comprises a voice/telephony/voice over IP server 410, for managing the voice channel if such channel is opened between the platform server and a user. Such channel is optionally used for playing prompts, transferring user input such as DTMF to the multimodality server, or the like. Platform server 400 further comprises a messaging server 413 responsible for sending and receiving messages to and from the mobile device. The number of the mobile device, the required service and other data is extracted from the massages sent from the mobile device. The messages can include SMS, GSM messages, IP based massages and others. Yet another component of platform server 400 is installation server 416 which handles the Installation process of one or more applications on the mobile device, for example a browser application. Platform server 400 comprises also session manager 419 with manages the active sessions in the system. Multi modality server 418 synchronizes between the voice/telephony/voice over IP server 410 and GUI server 408, and transfers user input to the application servers, such as application server 404. The apparatus can optionally comprise a content server 432, which can be part of platform server 400 or be executed by a different computing platform. Content server 432 is an auxiliary component which maintains the content of the application to be fetched by GUI server 408 and/or voice/telephony/voice over IP server 410. The apparatus optionally comprises one or more application servers, for executing specific application logic. Platform server 400 also optionally maintains one or more Abstract Program interfaces (APIs) 412. Each API 412 comprises functions to be implemented by applications provided by one or more service providers. The API is preferably used with one or more specific applications on the client side, such as specific application 1 (314) of FIG. 3. For example, a server may comprise an API for a ticket purchasing and reservation application. Application server 404 providing this service has to implement these functions for its halls or stadiums. The functions may include a function that queries the server for the number of rows in the hall or stadium, the number of seats in row X, and the like. Data network layer 406 of platform server 400 then communicates this information to the client, and the specific application, such as specific application 1 (314) of FIG. 3 can use the information to present in an optimized visual manner the relevant hall or stadium. Thus, a specific application service provider only has to implement the functions of the API for its own halls or stadiums to enable its customers to use the service. Application server 404 comprises one or more specific applications 420, implementing the logic specific to the server, billing, or other functionalities. Specific application 420 preferably comprises the implementation of API 412. Each application server 404 may comprise specific application functionality, implementation of API or both. Application server 404 further comprises server communication component 424 for communicating with server 400, and client communication 428 for communicating with client devices. Thus, application server 404 may communicate directly with the clients, or indirectly platform server 400.

In preferred embodiments, when the specific service provider does not allow the data transferred between the provider and its customers to be exposed to a third party, platform server 400 and application server 404 are the same entity, thus eliminating the need of server communication 424 and client communication 428. Further, specific application 420 simply implements whatever functions are required, without having to adhere with an API.

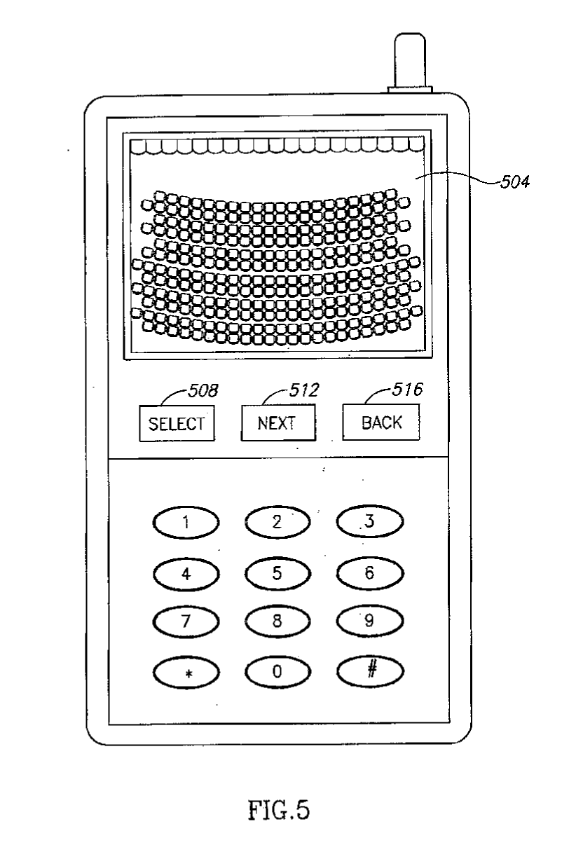

Referring now to FIG. 5, showing an exemplary user interface of an application for reserving tickets. A user using a mobile device 500 sends an SMS or dials a number, such as 1-300-8587, which is easy to remember since it is made of the numeric values corresponding to 1-300-tkts. After the call is hanged, or the SMS is received, a wake up SMS is sent to the mobile device which wakes up an application. By using the mobile device, the application establishes a data session with a server that directly or indirectly provides the required service. The data session optionally includes internet browsing, but this is not mandatory. The session may include accessing an IP address which is not a browsable page. The application retrieves data from the server, and presents the data with the specific user interface 504. Selections of the user, such as when pressing or otherwise indicating buttons 508, 512, 516 are transferred to the server and handled.

The disclosure presents method and system for initiating a data session from a mobile device by dialing a sequence of digits. The initiated session is a multi modal session, which enables transfer of data, audio, video, images, text, and any other type of information. In a preferred implementation, the session is initiated by the user dialing to a server, or by a listener application trapping the dialed digits or the sending event. An application installed on the mobile device for consuming the services optionally comprises an internet browser suited for the specific mobile device, for use in applications which are supplied through web browsing. The application can further comprise additional capabilities for example for utilizing the display, updating parts of the display in real-time, adding speech-to-text capabilities for transferring vocal commands made by a user, or text to speech capabilities for supplying voice, enabling vocal popup-up messages for drawing the attention of the user, and others. The combination of the various modalities provides efficient usage of the relatively small display. Some of the logic related to an application can be implemented in the client and some on the server, for example checking the structural validity of a password, updating the user interface according to the user's choices or the like can be performed on the client side, in order to avoid the round0trip of information, decrease response time and enhance security.

While some applications such as application 308 may be general and require only standard browsing capabilities, specific applications such as specific application 1 (314) or specific application 2 (316) may comprise any type of information, including but not limited to: tickets purchasing or reservation; transportation-related applications such as route planning and ticket reservation, including presentation of maps, tables, images and other required data; mobile commerce applications, i.e. commerce applications initiated from a mobile device; gaming applications; virtual reality applications; banking and stock quote applications; arrival and departure time presentation applications or other transportation-related applications including for example map presentation abilities; medical related applications; fashion and other commerce related applications; food or restaurant related applications; or any other application.

In preferred embodiments of the disclosure, an application or a specific application such as specific application 1 (314) may comprise a button or a sensitive area, that when pressed issues a request for a human representative to assist in the session. Such assistance can use voice over IP or PSTN based phone call to transfer information between the consumer and the representative, in addition to the regular data exchanged, including video, audio, data, text and others. Two sessions, including a voice session and a data session can be held in parallel between the representative and the user of the mobile device.

In a preferred embodiment of the disclosure, under the user's consent, the representative can assume control over the mobile device, send images to be shown on the device for example to show the user various options, make the choices for the user in order to instruct him on using the applications or the like.

In preferred embodiments of the disclosure, if the server does not recognize the calling number, then it is possible that the application is not installed on the mobile device yet. In this case, the wake-up signal may comprise the executable to be installed, optionally together with a text message comprising instructions on how to install the application. The application preferably comprises a “save” option for enabling a user to stop the communication and continue it later from the same status. In preferred embodiments, the initially dialed number can also comprise letters and is not limited to digits.

It will be appreciated by a person skilled in the art that additional component can be used, which presents a desktop-like or a portal-like application to a user, the desktop application comprising icons or other links to all relevant specific applications used in accordance with the disclosure. The application can provide tools for adding, deleting or otherwise managing the applications, a connection to a server through which new services can become known and used, and other such utilities. It will further be appreciated that a user can save on the mobile device a screen shot, information or any other indication, for example a barcode or another purchase proof to be presented when collecting purchased goods.

It will also be appreciated that commercials can be sent to the mobile device by one or more service providers during a session or between sessions. The commercials can be sent as SMS, GSM messages, images, videos or in any other format. The commercials can further be personalized and specifically selected for the user of the device.

It will be appreciated by persons skilled in the art that the present disclosure is not limited to what has been particularly shown and described hereinabove. Rather the scope of the present disclosure is defined only by the claims which follow.

1. A method for starting an application providing a service from a mobile communication device, the method comprising the steps of:
generating a digital signal sequence;
determining the service to be provided using the digital sequence; and
starting execution of the application providing the service by the mobile communication device.

2. The method of claim 1 wherein the application is a multi modal application.

3. The method of claim 1 further comprising a step of a listener application trapping the digital signal sequence and starting the execution of the application.

4. The method of claim 3 wherein the listener application determines the application or a parameter thereof by matching a prefix or a suffix of the digital signal sequence.

5. The method of claim 3 wherein the listener application determines the application or a parameter thereof by comparing the digital signal sequence to an at least one predetermined number appearing in a table.

6. The method of claim 1 further comprising the steps of:
sending the digital signal sequence to a server; and
sending a notification from the server to the mobile communication device.

7. The method of claim 6 wherein the notification is sent as a separate communication between the mobile communication device and the server.

8. The method of claim 6 wherein the notification is sent as part of a communication established when the digital signal sequence was sent to the server.

9. The method of claim 6 wherein the notification comprises an address for the mobile communication device to connect to.

10. The method of claim 6 further comprising a step of a establishing a multimodal session between the mobile communication device and an Internet Protocol address associated with the service.

11. The method of claim 10 wherein the multi modal session comprises a voice session held substantially simultaneously with a data session.

12. The method of claim 11 wherein the session is between a user of the mobile device and a representative, and wherein the representative assumes control over the mobile device.

13. The method of claim 6 wherein the service is associated with the digital signal sequence or a part thereof.

14. The method of claim 6 wherein the notification is a Global System for Mobile communications message or a short message.

15. The method of claim 6 wherein the notification is a Wireless Application Protocol link.

16. The method of claim 15 wherein the application is a browser application.

17. An apparatus for starting an application providing a service, the application executed by a mobile communication device, the mobile communication device executing:
a listener application; and
the application providing the service to a user.

18. The apparatus of claim 17 wherein the listener application traps a digital signal sequence dialed by a user using the mobile communication device.

19. The apparatus of claim 17 wherein the application invokes a multimodal session between the mobile communication device and a server.

20. The apparatus of claim 19 wherein the server executes:
a network layer for communicating with the mobile communication device;
a messaging server for sending or receiving messages to and from the mobile communication device; and
a graphic user interface server for adapting information to be displayed to the user to an at least one parameter of the mobile communication device.

21. The apparatus of claim 20 wherein the messaging server sends a message to the mobile communication device to start the application.

22. The apparatus of claim 20 wherein the server further executes:
a voice server for receiving and sending vocal information from or to the mobile communication device; and
a multi modality server for synchronizing data between the voice server, the graphic user interface server and the mobile communication device.

23. The apparatus of claim 19 further comprising an application server for providing the service.
